(19) United States
(12) Patent Application Publication
(10) Pub. No.: US 2009/0299522 A1
(43) Pub. Date: Dec. 3, 2009

(54) ONLINE SMART PILL BOX DISPENSING SYSTEM

(76) Inventors: Joram Savir, Ramat-HaSharon (IL); Gilad Ben-Zur, Gan-Ner (IL)

Correspondence Address: MARTIN D. MOYNIHAN d/b/a PRTSI, INC., P.O. BOX 16446, ARLINGTON, VA, 22215, US

(21) Appl. No.: 12/411,471

(22) Filed: Mar. 26, 2009

Related U.S. Application Data
(60) Provisional application No. 61/064,808, filed on Mar. 27, 2008.

(51) Int. Cl. G06F 17/00

(52) U.S. Cl. 700/240; 700/242

(57) ABSTRACT

An integrated system for automatic, accurate controlled and monitored online pill dispensing. The system has a vacuum based dispensing mechanism capable of individually select any number of pills from any of the programmable drug containers and prepares the required dosage in an easy to reach compartment. The pills are stored in the smart pill box filled by either the pharmacy according to doctor's prescriptions or by the patient with Over The Counter (OTC) pills. The system automatically detects the content of each smart pill box and its prescribed daily dosage to eliminate human errors. The system provides online information to the patient's Health Insurance Provider such as Drug Consuming Compliance, necessary data for drug interactions predictions and refill requests directly to the pharmacy in accordance with the health insurance provider policy.

### RELATED APPLICATION

This application claims the benefit of priority of U.S. Provisional Patent Application No. 61/064,808 filed on Mar. 27, 2008, the contents of which are incorporated herein by reference.

### FIELD AND BACKGROUND OF THE INVENTION

1. Field of the Invention

The invention concerns a mode starting with filling pill boxes by the pharmacist and continues with facilitating pills, capsules and/or any medications dispatch, distribution and patient-based intake in a predictable and safe (error free) and programmable approach. The pills are stored in programmable drug containers (smart pill box) with ‘built in’ information regarding the content of the container, the prescribed dosage, recommended intake intervals and/or food interactions, the prescribing physician, the medical indication etc. The information is stored in the container by an integrated memory or RFID or can be accessed through the internet from an On-Line database identified by a Bar Code on the container. The initial information is prepared and programmed by the pharmacist while filling the prescription according to the Doctor's prescription.

The prescribed (or OTC) pills are to be dispensed in a Drug ergo-grip drawer. After preparing the required dosage the system alerts the patient by means of Audio alerts and/or by sending SMS to the patient's personal Cell Phone based upon his selection mode.

2. Prior Art

Current pill dispensers are mainly concern with the mechanical aspects of creating a timely dosage to a single user. This approach does not deal with the overall problems related with daily usage of large quantity of multiple pills few times a day especially by the elderly. The main deficiencies of exiting systems include:

a. Errors that are caused by a mismatch between the actual container content and the information available to the dispenser controller causing the patient taking different dosage and/or errors in time intervals vs. the recommended mode of administration.
b. Problems that may occur due to unrecognized adverse drug interaction. An example is two or more different pills that were prescribed by different doctors that the patient is required to take in a conflicting manner.
c. Current systems do not provide feedback to the patient's health insurance in regard to his drug usage compliance i.e. what type of medication patient takes regularly and does the patient takes them as prescribed by his doctor.
d. Current systems do not verify that the content of the container matches the prescribed drug. Such feature can reduce errors caused by human errors while filling a prescription.

### SUMMARY OF THE INVENTION

It is the aim of the current invention to provide some or all of these features:
To provide pharmacies with standard containers with integrated memory or RFID to be used for prescription filling.
To provide pharmacies with computer based system that will enable the pharmacist to both program the container integral memory with all required prescription information and to create the required labeling including specific BARCODE.
To enable the pharmacist, the health insurance provider, the doctor and the patient access to a secured and/or authorized online database with information relevant to the patient prescription to be used by the integrated system for dispensing medications.
To provide the patient with an electronically controlled online smart pill box dispensing system capable of holding any number (depending on apparatus size) of the programmed containers.
To provide the apparatus with inherent capabilities to read the information programmed into the container and/or contained in the BARCODE regardless of the container insertion chamber.
To provide the apparatus with the inherent movement of the picking head and/or the container to reach any container and to pick any pill by use of the included vacuum nipple.
To provide the apparatus the ability to be programmed through a dedicated control panel and/or by the patients home PC.
To provide the apparatus one or more drug ergo-grip drawers to be used by one or more patients.
To provide the ability to use such an apparatus in Hospitals and/or nursing homes to enable multiple patients environment benefiting from the automatic dose generating system
To provide an improved home-based pharmacotherapy distribution mechanism using an automated controlled medication dispenser.

### BRIEF DESCRIPTION OF THE DRAWINGS

The drawing show certain scheme concepts as currently preferred. These schemes are illustrative rather than limiting, and reference should be made to the attached claims to determine the scope of the invention. In the drawings,

FIG. 1 is a general block diagram illustrating the overall elements constructing and participating in the invention.

FIG. 2 is 3D view showing 10 containers apparatus.

FIG. 3 is a 3 D top view of the tray holding 10 containers of the apparatus shown in FIG. 2.

FIG. 4 is a 3D bottom view of the tray holding 10 containers of the apparatus shown in FIG. 2.

FIGS. 5, 6 and 7 are detailed 3D views of the programmable drug container.

FIG. 8 is a 3D view of the X, Y, Z moving mechanism of the apparatus shown in FIG. 2.

### DETAILED DESCRIPTION OF THE DRAWINGS

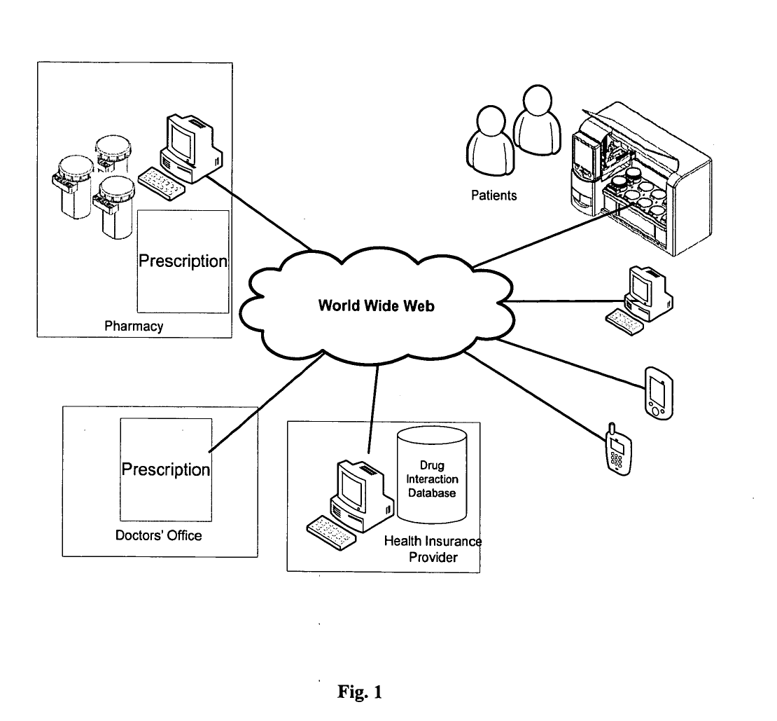

FIG. 1 is a general block diagram illustrating the overall elements constructing and participating in the invention. The Physician prescribes the patients with their prescription. The pharmacy, through the use of a specific filling program, fills the prescribed drugs into the programmable drug containers, programs the container with all required information and prints both labels for the container (Prescription details and Bar Code). The Patients are attaching their drugs containers to their Online Integrated Medication Dispensing System. The information regarding the specific content and usage of the prescribed drugs is checked at the Health Insurance Provider database for any adverse drug interaction. Once authorized by the Drug Interaction Database of the Health Insurance Provider the patients can start consuming their daily intakes as per their prescription by means of the automatic dispensing and alerting of the apparatus of FIG. 2. The apparatus will forward to the Health Insurance Provider Daily/Weekly/Monthly reports of the patients drug intake compliance. In addition, for chronic type drugs, the apparatus will generate automatic refill requests to be processed in accordance with Health Insurance Provider Policy.

FIG. 2 Illustrates a 3D view of the apparatus showing (1) a local display and controller capable of programming the apparatus and/or any container. It displays in addition alerts to the patients such as Fault indication or “Drug Interaction Alert”. It will also indicate inventory information and/or description of the dispensed drugs and the patients' name. (2) Ergo Grip Drawer where the patients collect their drug dosage. (3) Child safe transparent hood. (4) X, Y, Z Vacuum mechanism by which the local controller is generating the current dosage according to the doctor's prescriptions. The mechanism is moving in X, Y plan to the selected container using the X, Y motors. Once reached the requested container the controller operates the vacuum pump and the Z motor to lower the vacuum nipple into the container. After capturing the required pill a CCD device is generating a real time view to be compared with the expected pill so as to reduce errors and the mechanism is moving to the selected Ergo Grip Drawer and releases the captured pill. The controller continues this process until the dosage is ready. (5) showing a programmable drug container insert to the apparatus container holding tray.

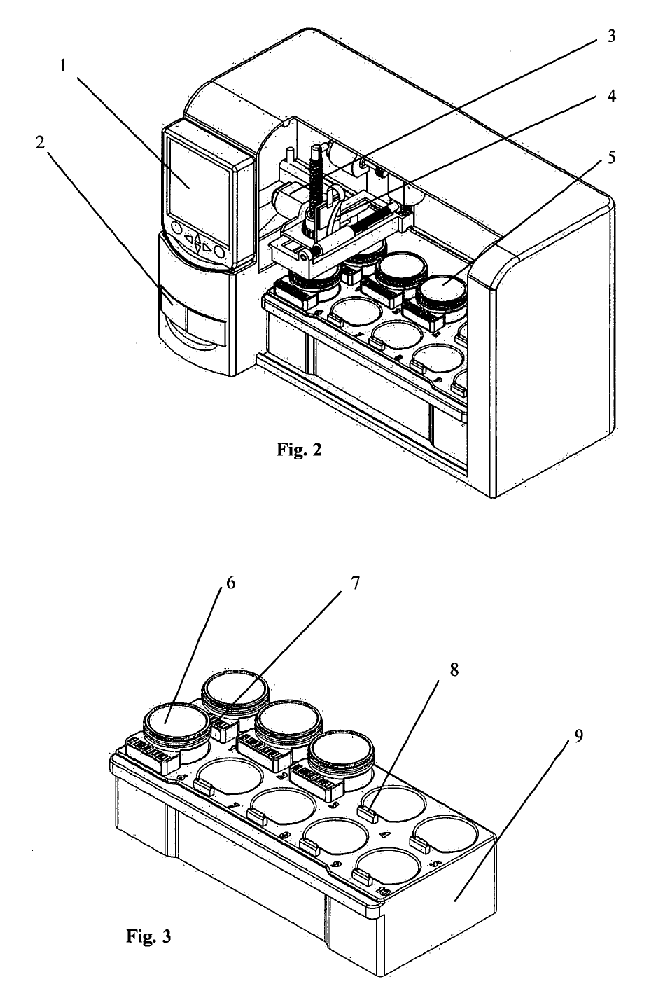

FIG. 3 is a 3D top view of the tray holding 10 containers of the apparatus shown in FIG. 2 showing (6) an open container inserted in a single available direction. (7) A BARCODE tag holding the identification information required for the controller and (8) Contacts for interfacing between the local controller and the programmable drug container so that the local container shall have all information required for generating the prescribed dosage. By use of either (7) and/or (8) the apparatus is minimizing errors generating from improper operation or human errors. (9) is a 3D view of the 10 programmable drug container tray.

FIG. 4 is a 3D bottom view of the 10 programmable drug container tray showing (10) an integrated vibrating device operated by the local controller. The vibration ensures that (a) each pill will be individually picked by the vacuum nipple and (b) the last pill in each of the containers will be at the planned central bottom of the container so that the vacuum nipple will be able to pick it up. (11) are four legs allowing the tray to vibrate in a controlled way once the vibrating device is operated by the local controller.

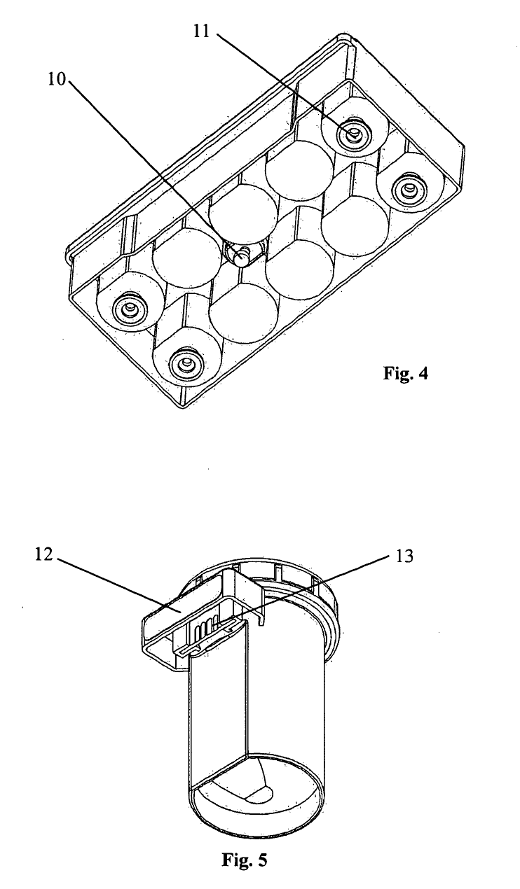

FIG. 5 is a 3D bottom view of the programmable drug container showing (12) placeholders for the drug description labels and (13) the integral programmable chip and connections to the apparatus.

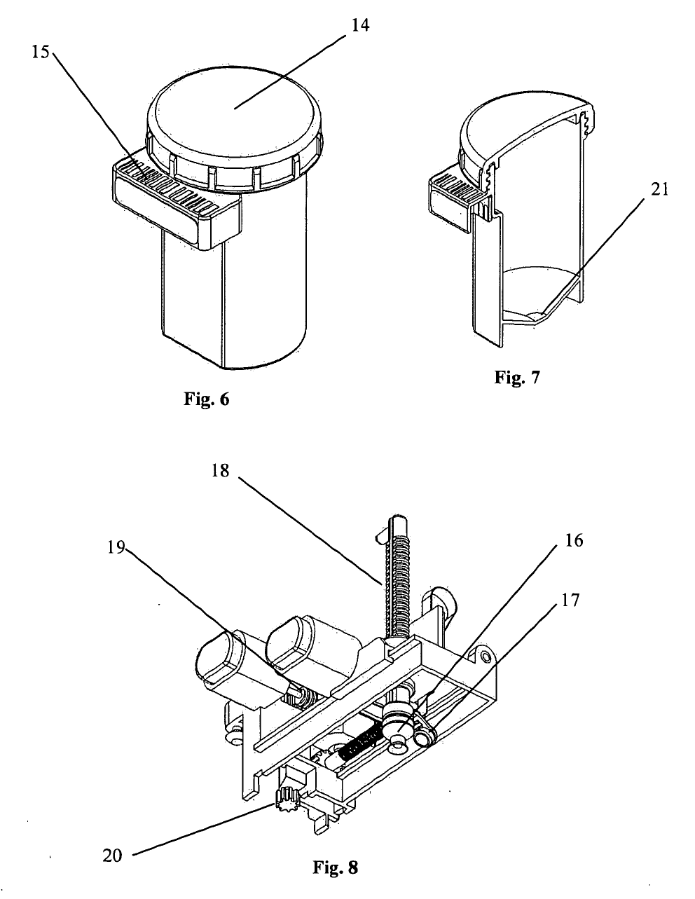

FIG. 6 is a 3D view of the programmable drug container showing (14) a regular/child safe cover and (15) placeholder for the BARCODE label.

FIG. 7 is a cut in a 3d view of the programmable drug container showing (15) a conical inner bottom used to facilitate the picking up of the “Last Pill” by the vacuum nipple.

FIG. 8 is a 3D view of the X, Y, Z moving head showing (16) a vacuum nipple used to pickup all types of pills including small, medium and large sizes with full and partial different shapes (oval, circular etc.) in different weights/orientations. (17) is an imaging device use for generating an image of the picked up pill. The image is compared with the expected image (size, color and shape) based on the information stored in the programmable drug container chip. (18), (19) and (20) are the 3 axis movement mechanism that enables moving the vacuum nipple to each container as well as to the Ergo Grip drawers. In addition (18) also connects the vacuum nipple to the vacuum pump by means of flexible pipe.

The invention being discussed with respect to examples including the preferred schemes show and discussed, it will be apparent the additional variation and combinations of features can be used as well. The invention is intended to encompass not only the foregoing examples, but also the range of variations that is met by the following claims.

1. Online smart pill box dispensing system comprising:
At least two chambers each chamber respectively holding a detachable programmable drug container with loose and randomly oriented pills a bottom of each container is conically shaped.
An integrated processor capable of: controlling all elements of the dispenser, reading/writing the programmed information in each container. The processor is capable of communicating over the internet and with a local PC.
A vacuum based pickup mechanism moveable on 3 axes X, Y, Z. A vacuum nipple is automatically inserted into any pill container through the 3 axis motors movement and picks up a single pill to be dropped into an ergo-grip drawer to become part of a prepared dosage. The pickup mechanisms also contain a small camera that provides image of the picked up pill in a digital form to the integral processor.

2. The medication dispensing system of claim 1, further contains a local keyboard and display allowing the user to locally program the medication dispensing system.

3. The medication dispensing system of claim 1, further enables the patient to load and program any of specific containers to be filled by him with such as Over The Counter pills and to be taken regularly as part of his daily dose.

4. The smart pill box dispensing system of claim 1, further automatically detects the content of each container, as programmed by the pharmacist system while filling the prescription, in any chamber and is using the programmed information in each container for any combination of the following:
a. Generate a timely dose of pills in accordance with the doctor's prescription and/or
b. Verifies through an internet connection to an online database whether there are any adverse drug interaction and/or
c. Check the conformity of any pill picked up through a digital image captured by the local camera with the anticipated properties of the prescription from the online database i.e. size, shape and color.

5. The smart pill box dispensing system of claim 1, further generates an audio/visual alarm when dosage is ready and/or sends SMS to the patient's personal phone.

6. The smart pill box dispensing system of claim 1, further sends a refill request to the patient pharmacy with notice to the prescribing doctor in accordance with the health insurance provider policy.

7. The smart pill box dispensing system of claim 1, further collects data regarding patients dose taking habits and can submit an online report to the patient's health insurance provider regarding the patient's drug compliance statistics.

8. The smart pill box dispensing system of claim 1, further includes external interfaces such as USB, Bluetooth, WIFI, WIMAX and Ethernet connection (10/100 Base and/or Fiber Optic) to enable direct connection to a PC and/or Cell Phone and/or Handheld device and/or Smart Phone and/or the WEB.

9. The smart pill box dispensing system of claim 1, further makes use of at least two types of smart pill box
a. Reprogrammable box for use with OTC pills.
b. Single use programmable box to be used by the pharmacy while filling a prescription.
